(19) United States
(12) Patent Application Publication
(10) Pub. No.: US 2009/0288999 A1
(43) Pub. Date: Nov. 26, 2009

(54) Water level control device for reverse osmosis water purifying system

(76) Inventor: Shih-Ping Lee, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,292

(22) Filed: Nov. 17, 2008

(30) Foreign Application Priority Data
May 20, 2008 (TW) 097208764

(51) Int. Cl. B01D 61/12

(52) U.S. Cl. 210/128

(57) ABSTRACT

A reverse osmosis water purifying system includes a base with a support platform on which a water container is put and a purifying unit is received in the base so as to provide purified water into the water tank. A water level control device has a magnetic float unit connected to the water tank and the magnetic float unit has a magnetic float which can be inducted by a first magnetic-spring switch and a second magnetic-spring switch located on the base. The first magnetic-spring switch is located below the second magnetic-spring switch. The magnetic float moves along with the water level and activates the first magnetic-spring switch or the second magnetic-spring switch respectively to control the pump to provide the purified water into the water tank.

### FIELD OF THE INVENTION

The present invention relates to a water level control device for preventing the water from overflowing from the water tank.

### BACKGROUND OF THE INVENTION

A conventional reverse osmosis water purifying system 5 is shown in FIG. 9 and generally includes a filtering unit 51 through which water is purified and collected in a water tank 52 and the water tank 52 is connected with a faucet 53 from which the user can have the purified water. The water tank 52 includes a permeable membrane 521 located transversely therein which defines an upper chamber 522 and a lower chamber 523 in the water tank 52. The purified water is stored in the upper chamber 522 and the lower chamber 523 is filled with pressurized air. When the faucet 53 is operated, the permeable membrane 512 is deformed upward by the difference of pressure to force the purified water in the upper chamber 52 to flow through the faucet 53. However, all the parts and components of the conventional reverse osmosis water purifying system 5 are installed beneath the countertop at distance so that long pipes are needed between the parts and components. The long pipes occupy space and increase possibility of contamination to the water.

FIG. 10 shows another reverse osmosis water purifying system 6 including a filtering unit 61 which includes an inlet pipe 61 at one end of the filtering unit 61 so as to be connected with a faucet 65, an outlet pipe 62 connected with a water tank 69, and an escape pipe 63 from which the unpurified water is sent out from the system. When the power is switched ON and the faucet is operated, the purified water can be obtained and the contaminated water is sent out from the system. However, the system does not have a water level control device so that the user has to check the water level frequently to prevent from overflowing from the water tank 69. The overflow water can be dispensed from the overflow pipe 66 and is a significant waste.

U.S. Pat. No. 6,764,594 includes a huge body and a complicated piping system. It requires to remove all the piping system before maintaining the interior components. The water level control device is operated mechanically and fixed to the body so that the users are difficult to judge the status of the water level control device.

U.S. Pat. No. 4,842,724 discloses a water tank which is fixed with the faucet and no water level control device available. The users have to add water manually and no proper signal is provided to inform the users. The disclosure relates to a water saving system and cannot be satisfied by the users who use modern reverse osmosis water purifying systems.

The present invention intends to provide a water level control device for reverse osmosis water purifying system, the water level is changed with a magnetic float which is detected by two respective magnetic-spring switches to prevent the purified water from overflowing from the water tank.

### SUMMARY OF THE INVENTION

The present invention relates to a reverse osmosis water purifying system and comprises a base having a purifying unit received therein and a support platform. An outlet is defined through the platform and in communication with the purifying unit. A water tank is removably rested on the support platform and has an entrance hole which is located corresponding to the outlet. A water level control device has a magnetic float unit connected to the water tank, and a first magnetic-spring switch and a second magnetic-spring switch are located on the base. The first magnetic-spring switch is located below the second magnetic-spring switch. The magnetic float unit has a magnetic float which is moved along with water level in the water tank and the magnetic float can be inducted by the first magnetic-spring switch or the second magnetic-spring switch respectively to activate a controller to feed purified water into the water tank.

The primary object of the present invention is to provide a water level control device for the water tank of the reverse osmosis water purifying system, wherein a magnetic float floats on the water level and inducts the first or second magnetic-spring switches to control the water level not to overflow the water tank.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the reverse osmosis water purifying system with the water level control device of the present invention;

FIG. 2 shows the back of the reverse osmosis water purifying system and two pipes are connected between the faucet and the reverse osmosis water purifying system;

FIG. 3 is an exploded view to show the water level control device of the reverse osmosis water purifying system of the present invention;

FIG. 4 shows the block diagram of the water level control device of the reverse osmosis water purifying system of the present invention;

FIG. 5 shows the one-way valve connected between the filter and the outlet of the base of the reverse osmosis water purifying system of the present invention;

FIG. 5A shows that the water is taken away from the base;

FIG. 6 shows that the water tank includes a reception recess for receiving the magnetic float unit;

FIG. 7 is an exploded view to show another embodiment of the magnetic float unit;

FIG. 8 shows the operation of the magnetic float unit in FIG. 7 in the water tank;

FIG. 9 shows a conventional the reverse osmosis water purifying system, and

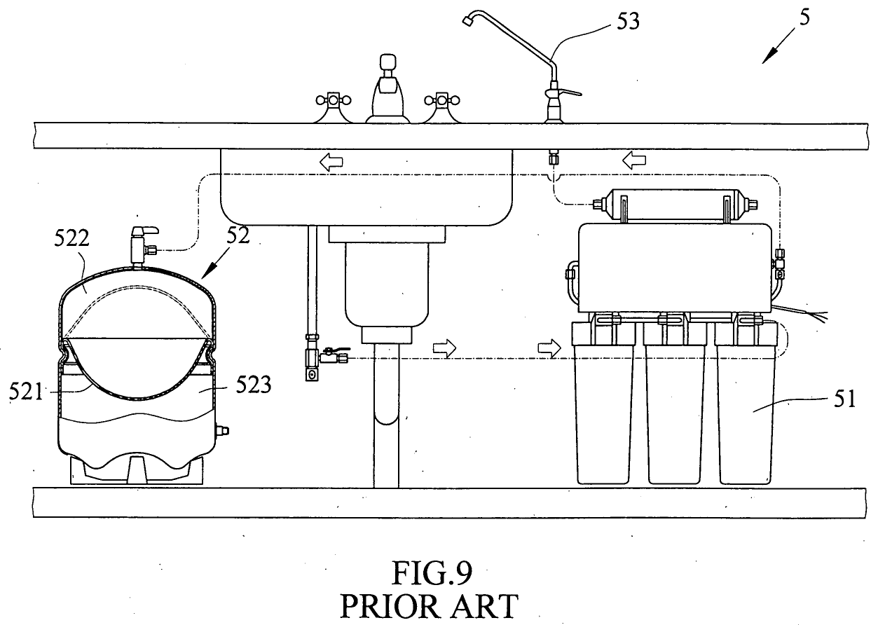

FIG. 10 shows another conventional the reverse osmosis water purifying system.

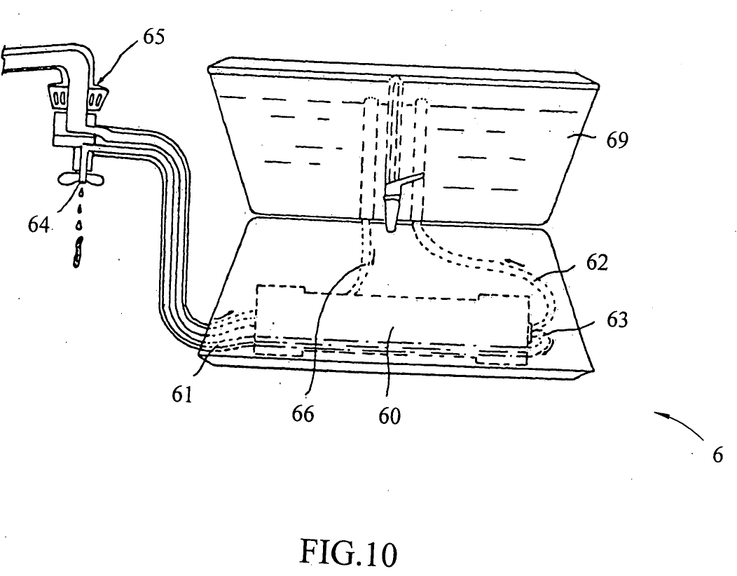

### DETAILED DESCRIPTION OF THE PREFERRED EMBODIMENT

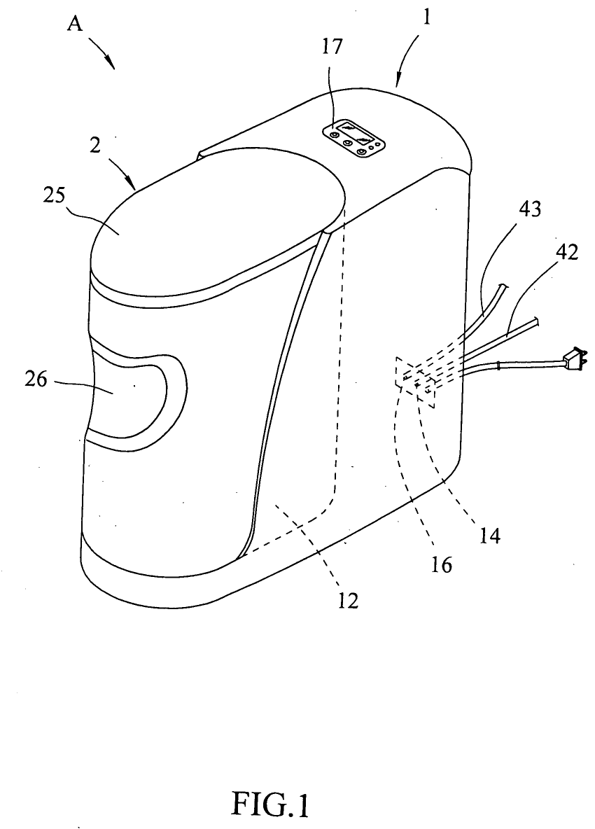

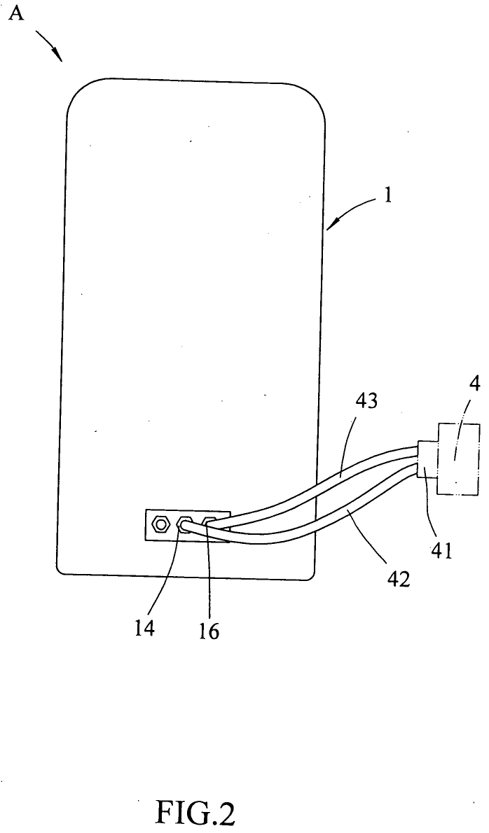

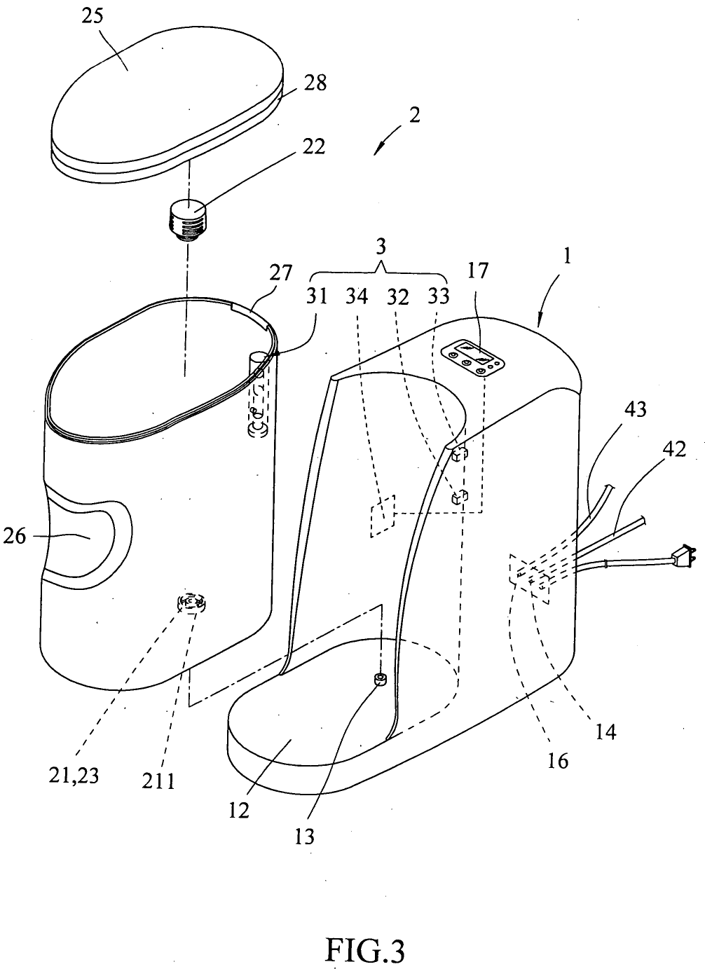

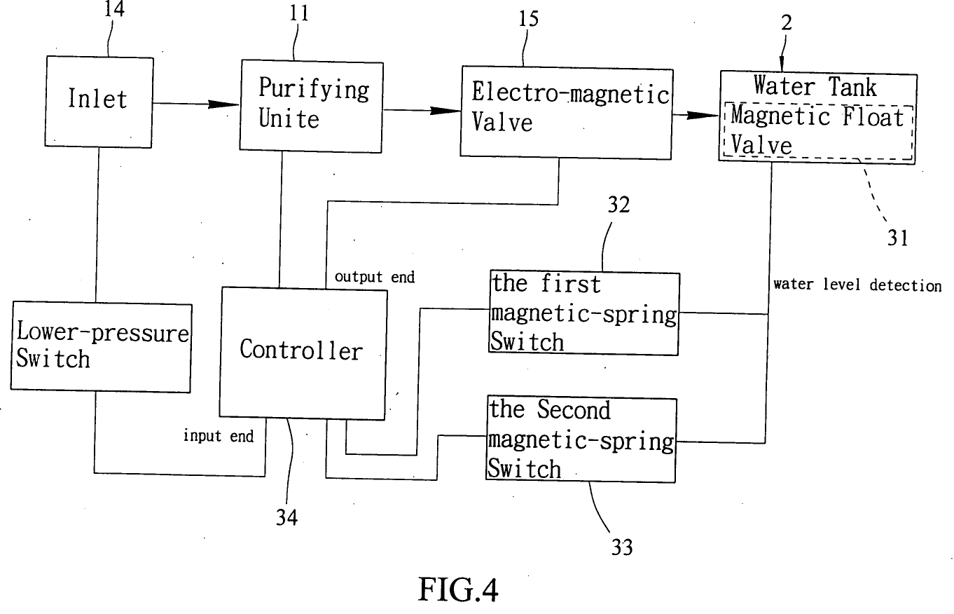

Referring to FIGS. 1 to 5, the reverse osmosis water purifying system “A” of the present invention comprises a base 1 having a purifying unit 11 received therein and a support platform 12 is defined in the base 1. An outlet 13 is defined in the support platform 12 and is in communication with the purifying unit 11. An inlet 14 is located on the outside of the base 1 and is connected with a faucet 4 by a three-way part 41 from which a supply pipe 42 and an escape pipe 43 are connected. The supply pipe 42 is connected with the inlet 14 and the escape pipe 43 is connected with an escape hole 16 defined through the base 1. A low-pressure switch is connected between the inlet 14 and the purifying unit 11 and detects the water entering the base 1. If the water is detected to enter into the base 1, the pump of the purifying unit 11 is activated to send the water into the purifying unit 11. An operation panel 17 is located on the top of the base 1 and connected with a controller 34 so as to display various statuses of the reverse osmosis water purifying system “A”.

A water tank 2 is removably rested on the support platform 12 and has an entrance hole 21 which is located corresponding to the outlet 13. The water tank 2 includes a holding portion 26 defined in an outside thereof for convenience of grasp of the users and a spout 27 is defined in a top edge of the water tank 2 so that the user can get the purified water from the spout 27. The entrance hole 21 of the water tank 2 includes a threaded hole 211 and a one-way valve 23 is threadedly connected to the threaded hole 211. A filter 22 is threadedly installed above the one-way valve 23 in the water tank 2 so as to ensure that the water is purified before stored in the water tank 2.

A water level control device 3 has a magnetic float unit 31 connected to the water tank 2, and a first magnetic-spring switch 32 and a second magnetic-spring switch 33 are located on the base 1. The first magnetic-spring switch 32 is located below the second magnetic-spring switch 33. The magnetic float unit 31 includes a chamber 311 defined therein and a magnetic float 312 is located in the chamber 311. The magnetic float 312 floats on the water level in the water tank 2. The magnetic float 312 can be inducted by the first magnetic-spring switch 32 or the second magnetic-spring switch 33. The first magnetic-spring switch 32 is electronically connected with the controller 34 so as to control an electromagnetic valve 15 in the base 1, the second magnetic-spring switch 33 is electronically connected with the controller 34 so that when the second magnetic-spring switch 33 detects the magnetic float 312, the controller 34 is cut off.

When the water tank is put on the support platform 12, and the entrance hole 21 is in alignment with the outlet 13, the push member 231 of the one-way valve 23 is pushed by the rod 131 in the outlet 13 so that the one-way valve 23 is opened to allow water to enter into the water tank 2. When the water level has not reached the pre-set position, the magnetic float 312 is located at lower position and inducted by the first magnetic-spring switch 32, the electromagnetic valve 15 is activated to let the pump of the purifying unit 11 feed the purified water into the water tank 2. When the water level reaches the pre-set position, the magnetic float 312 moves upward and the first magnetic-spring switch 32 cannot detects the magnetic float 312, the pump is stopped and the purified water does not supply to the water tank 2.

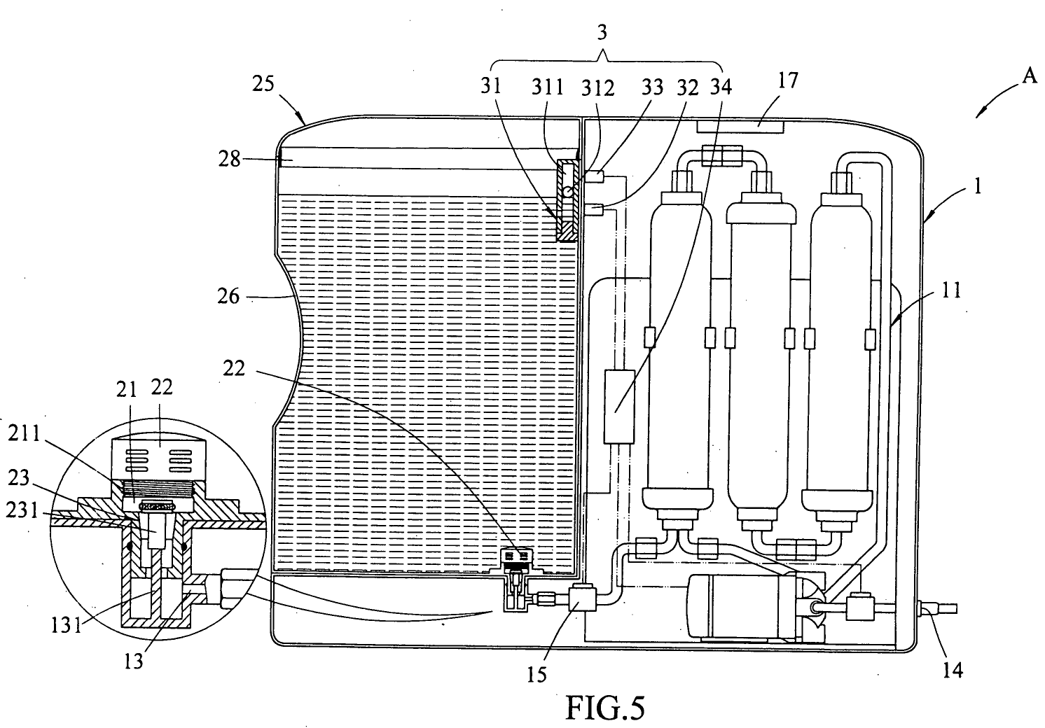

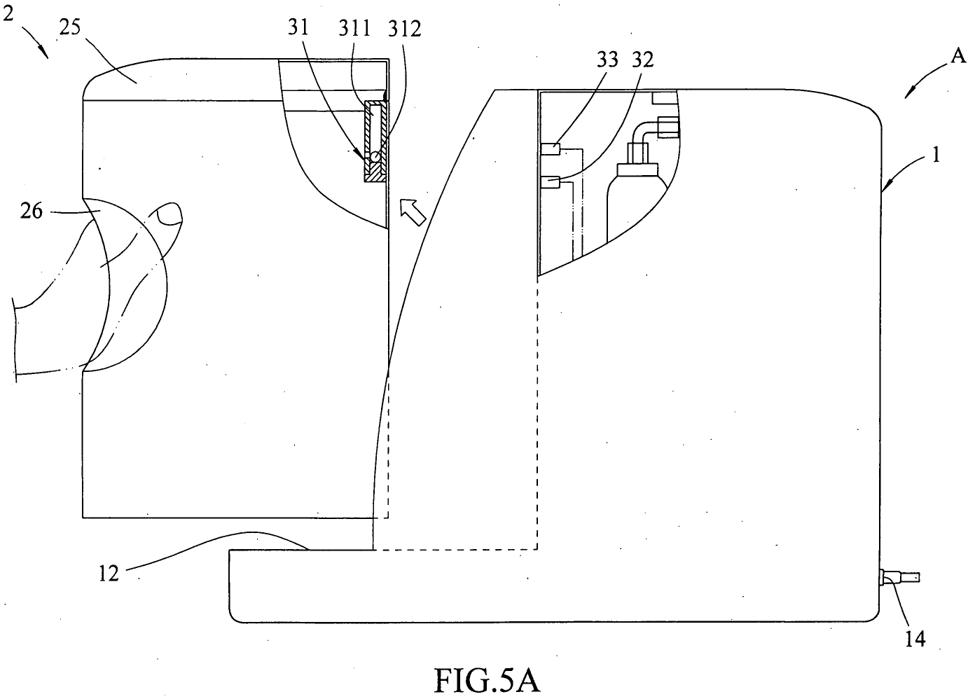

As shown in FIG. 5A, when the user takes the water tank 2 from the support platform 12 while the purifying unit 11 is working, the one-way valve 23 is sealed because the rod 131 no longer pushes the push member 231 and the purified water in the water tank 2 does not leak from the entrance hole 21. The electromagnetic valve 15 is stopped so that the water is not pumped. When the purified water is poured out from the water tank 2 via the spout 27 and the water tank 2 is put back to the support platform 12, the water level is lowered and the magnetic float 312 floats on the water level and detected by the first magnetic-spring switch 32, so that the pump works again to feed the purified water into the water tank 2.

The water that is not purified can escape from the base 1 via a pipe connected between the base 1 and the escape hole 16, and the escape pipe 43.

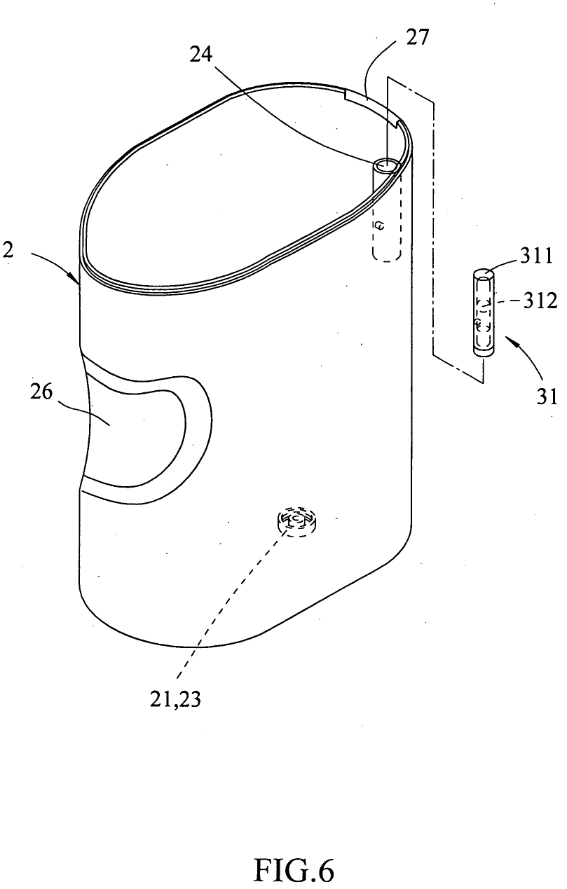

FIG. 6 shows that the magnetic float unit 31 can be an elongate body and water tank 2 includes a reception recess 24 defined therein, the magnetic float unit 31 is received in the reception recess 24. The magnetic float unit 31 includes the chamber 311 and the magnetic float 312 is located in the chamber 311.

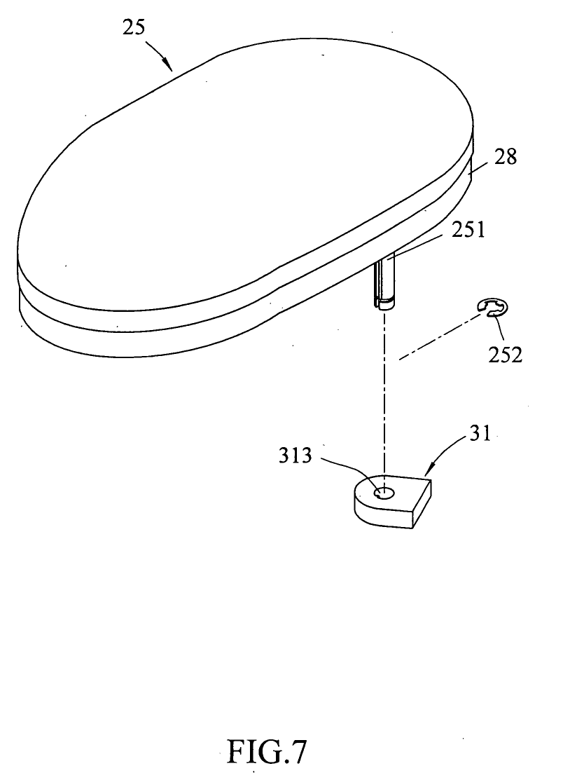

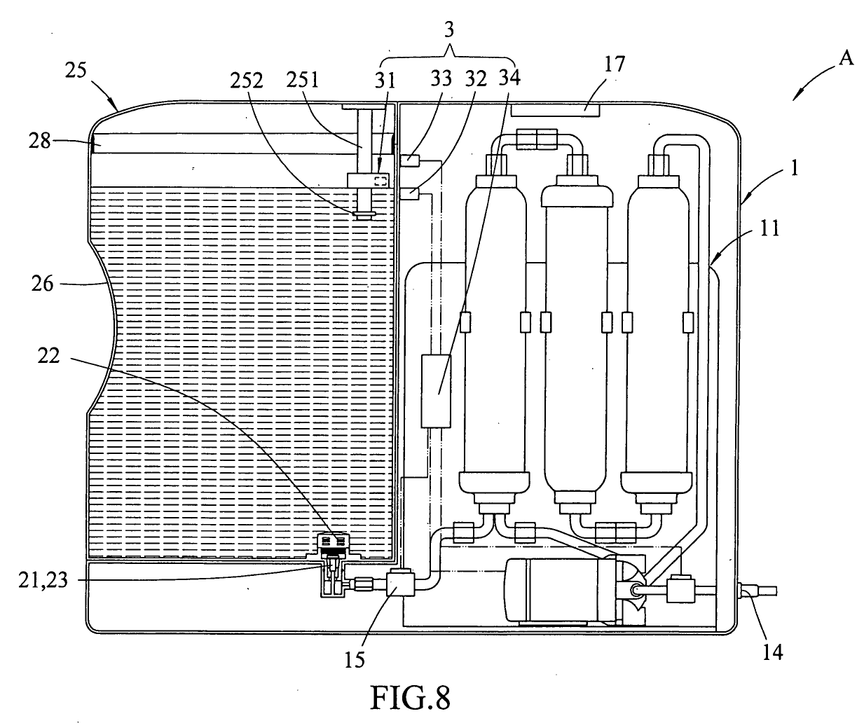

FIGS. 7 and 8 show that the magnetic float unit 31 can be a block with a through hole 313 in which a magnetic piece is received. A guide member 251 extends from an underside of a cover 25 mounted on the water tank 2, the magnetic float unit 31 is movably mounted to the guide member 251 which extends through the through hole 313. A clip 252 is securely connected to a lower end of the guide member 251 so that the block does not drop from the guide member 251. The magnetic piece in the block can be inducted by the first and second magnetic-spring switches 32, 33. In order to prevent leakage, a seal ring 28 is connected between the cover 25 and the open top fo the water tank 2.

If the water level is too high, the magnetic float 312 is inducted by the second magnetic-spring switch 33 to cut off the power of the controller 34. When the second magnetic-spring switch 33 detects the magnetic float 312, the control panel 17 shows a warning signal which informs the users that the first magnetic-spring switch 32 does not function properly.

While we have shown and described the embodiment in accordance with the present invention, it should be clear to those skilled in the art that further embodiments may be made without departing from the scope of the present invention.

What is claimed is:

1. A reverse osmosis water purifying system comprising:
a base having a purifying unit received therein and a support platform through which an outlet is defined which is in communication with the purifying unit;
a water tank removably rested on the support platform and having an entrance hole which is located corresponding to the outlet, and
a water level control device having a magnetic float unit connected to the water tank, a first magnetic-spring switch and a second magnetic-spring switch located on the base, the first magnetic-spring switch located below the second magnetic-spring switch, the magnetic float unit being inducted by one of the first magnetic-spring switch and the second magnetic-spring switch.

2. The reverse osmosis water purifying system as claimed in claim 1, wherein the entrance hole of the water tank includes a filter received therein.

3. The reverse osmosis water purifying system as claimed in claim 2, wherein the entrance hole has a one-way valve received therein.

4. The reverse osmosis water purifying system as claimed in claim 1, wherein the magnetic float unit includes a chamber defined therein and a magnetic float is located in the chamber.

5. The reverse osmosis water purifying system as claimed in claim 1, wherein the water tank includes a reception recess defined therein and the magnetic float unit is received in the reception recess.

6. The reverse osmosis water purifying system as Claimed in claim 5, wherein the magnetic float unit includes a chamber defined therein and a magnetic float is located in the chamber.

7. The reverse osmosis water purifying system as claimed in claim 1, wherein a guide member extends from an underside of a cover mounted on the water tank, the magnetic float unit is movably mounted to the guide member and a clip is securely connected to a lower end of the guide member.

8. The reverse osmosis water purifying system as claimed in claim 1, wherein the water tank includes a holding portion defined in an outside thereof.

9. The reverse osmosis water purifying system as claimed in claim 1, wherein the water tank includes a spout defined in a top edge thereof.

10. The reverse osmosis water purifying system as claimed in claim 4, wherein the magnetic float moves along water level in the water tank and inducted by the first and second magnetic-spring switches respectively.
